(19) United States
(12) Patent Application Publication
(10) Pub. No.: US 2009/0014383 A1
(43) Pub. Date: Jan. 15, 2009

(54) On/off site water reclamation system

(76) Inventor: Roger J. Owley, Henderson, NV (US)

Correspondence Address: ROGER J. OWLEY, 550 PARKSON ROAD, HENDERSON, NV, 89011-4069, US

(21) Appl. No.: 11/825,825

(22) Filed: Jul. 9, 2007

(51) Int. Cl. C02F 3/30

(52) U.S. Cl. 210/605; 210/617; 210/151

(57) ABSTRACT

This on/off-site WATER RECLAMATION SYSTEM is disclosed suitable for domestic or other sewage. After separation of the settleable solids, the effluent is passed into a basin holding particles of a media through (around) which the effluent travels. The media beds substantial reduce the amount of the suspended solids (SS) and BOD (biological oxygen demand) and FC (fecal coliform) by bacterial action and oxygenation as well as substantially reducing the nitrate (N) level and provide a high oxygen content filtrate discharge. The filtrate is collected and dispersed over the surface of the same media bed for travel there through a second or more times. The effluent carries oxygen from the air into the media. The media retains the effluent until the surface tension is overcome by gravity and discharged from the system. This on/off-site WATER RECLAMATION SYSTEM produces a quality discharge to meet the requirements.

### BACKGROUND OF THE INVENTION

1. Field of Invention

This invention relates to an on/off-site WATER RECLAMATION SYSTEM and on/off-site method of recovering wastewater.

2. Prior History and State of Art

Relevant to the Disclosure On/Off-site disposal of wastewater (sewage) from single family residences, communities, villages and commercial establishments in areas with no conventional sewer system has conventionally been accomplished by a septic tank system where the anaerobic effluent discharged from the septic tank, after settling of the solids portion of the incoming wastewater, is passed into a subsurface drainfield, pit, cesspool, soaks for percolation into the surrounding soil. Such a system works satisfactorily if properly installed and if proper soil conditions for disposal of the effluent by the drainfield exist. In many areas, soil conditions are unsuitable for treatment of the effluent from septic tanks. In such areas one alternative is to utilize small treatment plants, which make use of chemical and/or biological treatment means, such as primary, secondary and sometimes tertiary treatment to render the effluent suitable for disposal. Such treatment plants are prohibitively expensive, both to construct and operate unless there is a sufficiently dense population base or industrial base for financially supporting the treatment plant. Such treatment plants as illustrated in U.S. patents listings prior to 1978, as is the case in U.S. patents granted thereafter.

To further elaborate, the wastewater treatment systems as described in U.S. Pat. No. 4,217,218 1980 Bauer, U.S. Pat. No. 4,229,296 1980 Wheaton, U.S. Pat. No. 4,251,359 1981 Colwell/Freeman, U.S. Pat. No. 4,272,383 1981 McGrew, all have similar short comings, in distribution as to reclamation of waste water alternating, intermittent or reactor distribution and processing reclamation systems.

And furthermore as illustrated in U.S, patents (insert dis, of list. us pat. items) By Hoechst, “The Biotech Reactor State of the Art in Biological Waste Water Treatment Brochure 8708/035E, Date Unknown

Norris, D. P., Parker, D. P., Danials, M. L., and Owens, E. L. 1982. “High Quality trickling Filter Effluent without Tertiary Treatment.” J. Wat. Poll. Cont. Fed., 54:1087-98
Osborn, D. W. “Sewage Purification In South Africa—Past and Present”, ISSN 0378-4738=Water SA Vol. No. 3. July 1998

### Chowdhury et al., “Catalytic Wet Oxidation of Strong Waste Water”, AlChE Symp. 151(71):46-58, 1975

Lu et al., “Selective Partical Deposition in Crossflow Filteration”, Sep. Sci. and Technol., 24(7&8):517-540, 1989
Armellilni and Tester, “Seperation During Supercritical Water Oxidation of Human Metabolic Waste Fundamental Studies of Salt nucleation and Growth, Society of Automotive Engineers, Inc. pp. 189-203, 1990
Dell'Orco et al., “The Study Of 1:1 Nitrate Electrolytes in Supercritical Water”, Los Alamos National Lab Report, LA-UR-92-3359, pp. 1-7 (continue) are generally not economically feasible for treatment/recovery of domestic sewage in rural and semi-rural areas. Other alternative methods of on-site waste treatment and disposal are known; however, many of them have never been accepted by local health authorities because of insufficient treatment of the wastewater and/or claim of reclamation.

### SUMMARY OF THE INVENTION

For purposes of this application, the term “media” used herein means an artificially constructed environment conducive to the growth and maintenance of aerobic bacteria organisms for the biological treatment of wastewater.

It is a primary object of this invention to provide a dependable on/off-site WATER RECLAMATION SYSTEM wherein wastewater, after solids separation, is passed through (around) particles of media in a bed, collected, and uniformly distributed a second or more times over and on the same media before being received in a separate media section and then discharged.

It is a further object of this invention to provide an on/off-site WATER RECLAMATION SYSTEM wherein effluent, after solids separation, is passed in the first section of media particles in a bed and then collected and then being uniformly dispersed over the media bed in the first section through which the effluent was initially passed and also over the second section of media particles.

It is a further object of this invention to provide an on/off-site WATER RECLAMATION SYSTEM wherein effluent, after solids separation, is passed through a particulate media at least twice or more times with periodic recirculation of the effluent before discharge from the second section of media.

It is a further object of this invention to provide an on/off-site WATER RECLAMATION SYSTEM wherein effluent, after solids separation, is passed into a subsurface area (first section) of a bed of particulate media which retains the effluent therein for a period of time after which it is displaced from the media, collected and uniformly dispersed over the top surface of the media sections for retention by the media a second time or more in the first section before being displaced and discharged by the dispersal entering the second section of media and final discharge from the process.

It is a further object of this invention to provide an on/off-site WATER RECLAMATION SYSTEM wherein the fecal bacterial count of the discharged effluent is reduced sufficiently to permit use of the effluent as process water for irrigation, double plumbing in houses, or other purposes.

It is a further object of this invention to provide an on/off-site WATER RECLAMATION SYSTEM wherein the nitrate level percentage of the discharged effluent is reduced sufficiently to permit use of the effluent as process water for irrigation, double plumbing in houses, or other purposes.

These and other objects are accomplished by a method and system for on/off-site WATER RECLAMATION SYSTEM of wastewater by effecting solid-liquid separation of the gravity settleable solids portion of the wastewater, passing the effluent with the solids removed into a bed comprising particles of media which retain the effluent therein for a period of time before displacement by partially processed effluent or additional effluent, collecting the displaced effluent, and uniformly dispersing the displaced effluent over the media beds (first and second) for retention and displacement a second time or more by the first media bed. The effluent after retention and displacement a second time or more through the media, while the effluent disbursed and received in the second section media bed is collected and discharged. A portion of the recirculation and/or discharge water can be directed back to the collection/septic tank or to the NRF 1 tank. In order to allow continuous use of the media without incurring problems of matting and clogging, the partially treated effluent is dispersed over the first and second section media beds to bring in oxygen, which allows the media beds to be used continuously.

### BRIEF DESCRIPTION OF THE FIGURES OF THE DRAWINGS

FIG. 1 is a perspective view of an on-site WATER RECLAMATION SYSTEM wherein the media basin includes multiple drain openings and wherein a portion of the effluent displaced from the bed is recirculated through the bed more than two times;

FIG. 2 is a plan view of FIG. 1

### DETAILED DESCRIPTION AND SPECIFICATIONS OF THE PREFERRED EMBODIMENTS

The combination of submerged or surface aeration and suspended solids particle size reduction occurs thereby creating a sufficient fluid flow within the biofilm aeration chamber. This combination of sufficient fluid flow, and reduced size suspended organic particles results in the efficient digestion of organic matter and pollutants by the biofilm growing on the biofilm support structure submerged in the biofilm aeration chamber. This results in a vastly more effective digestive process than conventional processes producing no sludge. Further, resulting treated effluent has a high dissolved oxygen, (D.O.), content and low BOD, SS, FC and N. The apparatus and process has the following advantages: low MLSS concentration, short biofilm incubation time, no clogging of the system, good response to shock loading, high D.O. in the effluent, consistent effluent quality, sludge is eliminated, wastewater RECLAMATION duration is shortened, the process is not temperature sensitive

The on/off-site WATER RECLAMATION SYSTEM as herein described may be used for treatment of domestic residential, communities, villages or commercial wastes which contain no significant amounts of heavy metals and/or synthetic organics of the type discharged from chemical treating and manufacturing facilities, electroplating industries or metal working industries unless pretreatment and elimination of the commercial wastes has been completed. The typical effluent from residential, communities, villages and commercial business establishments consists primarily of human waste in admixture with biodegradable materials such as food etc.

The wastewater to be reclaimed generally contains gravity settleable solids. While any means of effecting solid-liquid separation may be used, the most commonly used method is a collection/septic tank into which the wastewater is discharged and the solids allowed to settle by gravity. The effluent leaving the septic tank is anaerobic, i.e. it is not exposed to air or aeration. The solids within the collection/septic tank are subjected to partial anaerobic degradation. Although collection/septic tank designs vary, the conventional septic tank is a vessel containing a bottom wall and side walls, generally of reinforced concrete and a top wall having inspection openings near the inlet and outlet of the vessel and a central opening for inspection and pumping of the solids from the tank when necessary. The tank is also generally provided with baffles near the inlet and outlet to prevent flow of solids from the outlet with the effluent.

The effluent leaving the collection/septic tank is received in a NRU tank. This NRU tank design varies and is a vessel containing a bottom wall and side walls, generally of reinforced concrete and a top wall have inspection openings near the inlet and outlet of the vessel and a central opening for inspection and pumping of the solids from the tank when necessary. The NRU tank is also generally provided with baffles to promote the correct bacterial growth and bacterial changes to enhance the wastewater RECLAMATION.

### Specifications as to this Sample of a Plurality of Design Availabilities of the Preferred Embodiment

The system described in this application combines certain features of the intermittent sand filter system, the Hines-Favreau system and the On-Site WASTEWATER TREATMENT SYSTEM in a way to create a more effective and efficient treatment/recovery system. As previously stated, the media making up the media bed is a material conducive to the growth and maintenance of aerobic soil type organisms for the biological treatment of wastewater. The media is preferably a material such as coarse sand; however, other irregularly shaped particulate materials such as particulate garnet, crushed glass, crushed rock, plastics, etc may be used. The particle size of the particulate material making up the media should not be so large that channeling of effluent through the bed occurs readily nor so small that hydraulic compaction of the bed occurs and prevents adequate drainage. The irregular shaped particles of coarse sand or other particulate media within the basin are separated by small interstices, which hold effluent by surface tension. The media bed may be evenly saturated with effluent and the effluent retained within the interstices of the media bed for a substantial retention time before its field capacity is exceeded, i.e. the amount of water the media bed will hold until the surface tension between the particulate particles is overcome by the addition of additional amounts of effluent and gravity. The retention/displacement cycle, which occurs in the system described in this application, does not occur to the same degree in either the intermittent sand filter system. In the intermittent sand filter system the action is primarily mechanical. There is no even dispersion of effluent over the surface of the filter media. The same is true of the Hines-Favreau system wherein a high degree of mechanical filtration and channelization of the filter bed occurs without the retention/displacement cycle of the effluent. The On-Site Wastewater Treatment System has had clogging and ponding. The coarse sand material should preferably fall within the following ranges with a uniformity coefficient of plurality to include efficiency if design, however, other granular media material having different grain size distributions will be used to accomplish the results desired herein may also be used. As to continuation of (including streamline) to include the complete and improvement settings and percentages as shown below, compared to others.

| Sieve Size | mm | Percentages |
|---|---|---|
| Passing a ⅜″ sieve | 9.51 | 100 |
| Passing a No. 4 sieve | 4.76 | 30-60 |
| Passing a No. 8 Sieve | 2.38 | 10-30 |
| Passing a No. 16 sieve | 1.19 | 2-8 |
| Passing a No. 50 sieve | 0.297 | 0 |

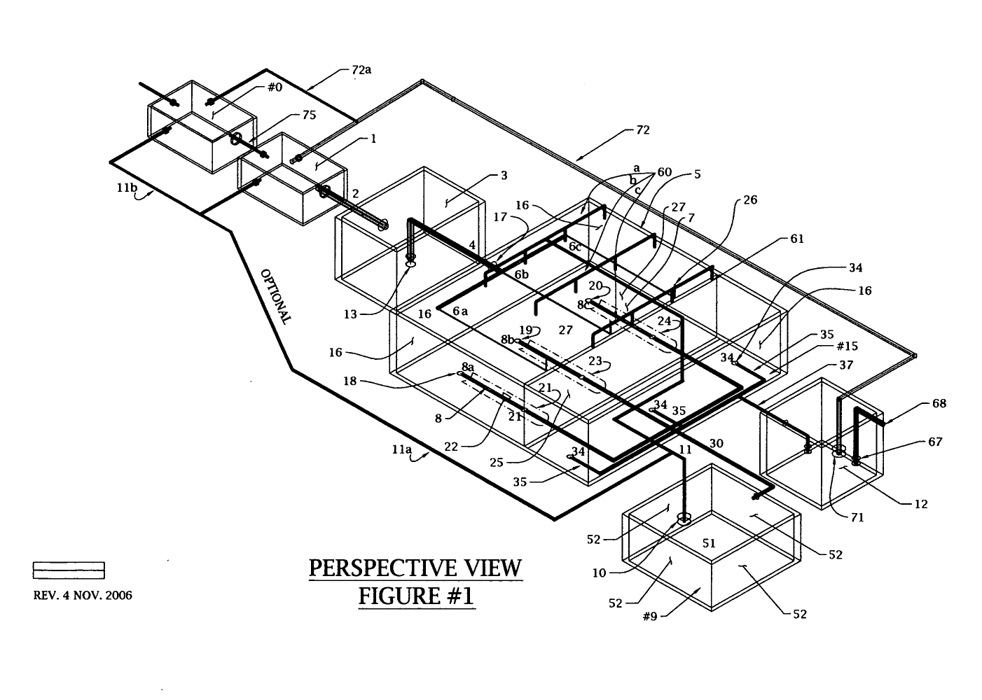

Referring to FIG. 1, wastewater flowing into a collection/septic tank 0 is discharged by gravity into line 75 that enters the NRU tank 1 the flow is discharged by gravity or pump into line 2 into the dosing tank 3 the influent is discharged by pumping or gravity into line 4 where it flows into the media basin 5 through one or a plurality of perforated subsurface pipe lines 6 extending substantially the length of the first section of the basin 5. The basin has a flat or sloped bottom wall and a single or multiple drain opening at the apex of the sloped or flat floor of the basin or side wall/s. The perforated pipelines 6 are placed about 6 inches below the top surface of the media and spaced evenly and are in the top layer of coarse rock media. In like manner, the designated design required drain opening/s, 18, 19, 20 or more is/are surrounded by a layer of coarse rock 22 media.

Effluent is displaced from the coarse sand media 7 in the basin through drain opening and drain line 8a, 8b, 8c or more into a recirculation tank 9 which includes a single or plurality of submersible pumps 10 as designated by system design and capacity, which pumps the displaced effluent through a valve and recirculation line 11 leading back into the basin 5 where it is intentionally dispersed by spraying through a single or plurality of nozzle spray heads over the top surface of the media 7 in the media basin 5, a portion of the effluent can be distributed through line 11b/a back to tank 0 or line 11a to tank 1. The effluent distributed uniformly over the surface of the first media section is retained by the media before being displaced again through drain lines 8a, 8b, 8c or more at which gravity fed into recirculation tank 9.

The submersible pump/s 10 in the recirculation tank 9 is preferably controlled with a controller programmed for intermittent and/or alternating operation and may also include high water and low water controls (not shown) for safety purposes.

The effluent distributed uniformly over the surface of the second media section by the recirculation tank pump/s 10 is retained by the media before being displaced through a line 37 leading to an optional discharge tank 12, at which option is designated at system design requirements, drainfield or otherwise disposed of, possibly sending a portion of the discharge water by pump 71 through pipe 72 to the NRF tank and/or line 72a to the collection/septic tank for improving the recovery/treatment reprocess.

Matting and clogging are prevented through degradation of the organic material by aerobic bacteria which receive oxygen as a result of the recirculated effluent distributed over the top surface of the media which carries dissolved oxygen with a combination of free oxygen into the media.

Referring to FIG. 1, effluent, after separation of the gravity settleable solids, is discharged through line 21 and flows into the recirculation tank 9 and a portion can be discharged through line 11b/a to the collection/septic tank and/or 11a to the a NRF tank 1 then is discharged through line 2 and flows into the dosing tank 3 where it is pumped by one of a plurality of pumps, 13, to basin 5 as will be described herein.

Basin 5 is a structurally covered basin that will keep out the elements and providing air vents to allow some air into the structure, the basin is preferably constructed of reinforced concrete or other suitable material, having a bottom wall 15 and side walls 16a, 16b, 16c and 16d. Side wall 16d provides as designed, opening/s, 17, therein at an calculated level for entry or the distribution line/s, 4, for the effluent as will be described herein:

The basin is sized to accept the amount of effluent to be recovered and this size, by design requirements, can be adjusted to increase the loading rate of the media from a single to a plurality of gallons input per day per square foot and to also provide a means so by adjusting the loading rate, this will affect the discharged quality. The bottom wall, 15, of the basin is provided with spaced drain openings 18, 19, 20 or more as spaced periphery drain openings as required by demand and design. Between the drains the portion of the bottom wall 15 of the basin, 5 is flat or can be sloped upward to a mid-rise point from which it slopes downwardly to the respective drain openings. The drain openings 18, 19 and 20 may or may not be connected by shallow trenches 21, 23 and 24 as illustrated in FIG. 1.

A wall 25 or separating membrane will be used to separate the first and second media basins. This wall or membrane can be adjusted by design to allow for varying strengths of influent and quality of treatment desired, which affects the recirculation volume and recirculation time.

The effluent is delivered from the dosing tank into the subsurface area of the first media section in the media basin by pumping or by gravity through subsurface pipe inlet lines 4 and 6, which enter the media basin through side wall opening 7. The effluent is distributed into the particles of the media bed through perforated pipes 6a, b, c and each of which is capped at their respective ends by suitable cap members 26.

The distribution lines 6a, b, c or more are provided with perforations along their entire length, preferably all of the perforations being on one side and positioned to point upwardly. Referring to FIG. 1 the basin is filled with particles of a media 7, such as coarse sand, of the type previously described to a depth of about seven eights the depth of the basin. The top one eight of depth is packed with the coarse rock 27.

Referring to FIG. 1 the line 4 leading from the dosing chamber 3 are provided with suitable valving such as gate valves to control discharge of the effluent to the distribution lines 6a, b, c or more. Check valves may also be provided in lines 4a, b. If desired, the submersible pump/s 13 which pump effluent from the dosing chamber 3 into line 4 will be provided with a controller for automatically alternating the pumps, high and low limit switches, or all of the above.

Depending on climatic conditions and other factors it may be desirable to enclose the basin in a structural enclosure. An enclosure over the basin may be used to control the ambient air temperature around the basin to ensure optimum operating conditions as well, the enclosure incorporating light filters to prevent plant growth on the surface of the media. Heat lamps irradiating the surface of the media in the basin, heat tapes in the basin, a heater in the tanks for the effluent, or other means may be used to maintain the media in the basin at an optimum temperature for bacterial action.

The effluent exiting through the perforations in distribution lines 6a, b, c or more is retained by the media until the surface tension between the effluent and particles of the media is overcome by additional effluent and the effect of gravity.

The effluent displaced for exit through drain openings 18, (inclusive to all). Each of the drains openings as illustrated in FIG. 1 connects with a common drain line (design requirements apply as to location), which carries the effluent by gravity to a recirculation tank 9.

The recirculation tank is illustrated in FIG. 1 and is preferably submerged below the level of the basin so that the effluent from the basin flows into the recirculation tank by gravity. Sizing of the recirculation tank depends on the capacity and sizing of the basin. The recirculation tank 9 as illustrated in FIG. 1 includes a bottom wall 51, side walls 52 and a top wall 53. Access to the recirculation tank is through opening/s in the top wall.

The submersible recirculation pump/s 10 is/are set in the recirculation tank as illustrated in FIG. 1. The outlet of the pump/s is connected to a recirculation line 11, which pumps the effluent through a series of lines 60a, b, c, or more connecting with a plurality of nozzles 61. The array of nozzles illustrated in FIG. 1 is exemplary. Other arrays may be used. What is desired is to inject the effluent into the air above the basin for even distribution of the effluent over the entire surface of the first and second sections of the media in the basin. The nozzles are sized and adapted to cover the entire surface of the media, effect optimum droplet size and application rate. A portion from pump 10 may or may not be directed through line 11b/a back to the collection/septic tank 0 or 11a to NRF tank 1. The pump/s are controlled by an electronic controller and software to assure correct operation. High water and lower water indicators of a conventional nature, such as floating mechanical/mercury switches, are preferably provided to activate and shut off the pumps necessary.

Primary control of the pump is by a controller software system. The volume of recirculated effluent that is displaced from the second media section in the basin collects and exits through drain openings 34a, b, c and connected to drain lines 35a, b, c.

The effluent discharged from the basin into the discharge tank may be discharged directly into a subsurface drainfield, discharged to a land application site, into a waterway or used as reclaimed water for landscape irrigation, for toilets, urinals or other such uses or a portion directed back to tank 0 or tank 1 through line 72 and 72a.

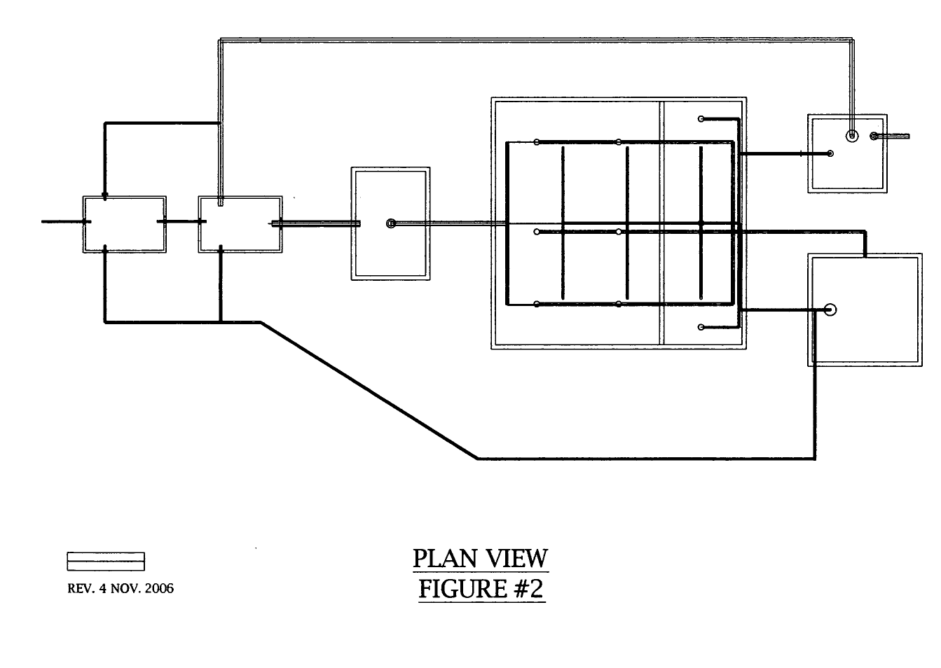

As previously described, sizing of the basin's recirculation tank, pumps, nozzles and other components of the system is dependent on the amount of loading of wastewater on the system. The following is an illustration of the system of FIGS. 1 to 2 but is not intended to be limiting in any manner.

Wastewater, after separation of the settleable solids in a collection/septic tank, exited the collection/septic tank through a pipe 4 inch or larger line 75 into NRU tank 1 exiting by pipe 2 to the dosing tank 3 that may be an integral part of the NRU tank provided with submersible pump/s 13. The pumps were fitted with a controller system providing high water and low water controls as well as means for alternating activation of the pumps and setting off an alarm system if either or both of the pumps failed to satisfactorily operate. Effluent from the dosing tank 3 was pumped through line 4 into subsurface distribution lines 6a, b, c which were designed to carry the flow 1 inch or more in diameter and provided with multiple perforations facing upwardly/outwardly. The distribution lines were set in a bed of media coarse rock 27 averaging about ¾″ to 1½″ particle size. The reinforced concrete basin having side walls approximately 5 feet high filled with coarse sand about seven eights full having a particle size as previously described. The top surface of the media rock was about 12 inches below the top of the side wall of the basin. The distribution lines 6a, b, c were set in the coarse media rock layer 27 about 6 inches below the surface of the coarse media rock 27. The layer of coarse media rock was about 6 inches in depth. All of the trenches connected with 4 inch or larger drain openings and 4 inch or larger drain lines, the drain line leading to the recirculation tank 9 and the drain lines 35a, b, c leading to discharge tank 12. The recirculation tank 9 of reinforced concrete was sized to contain about 60 percent of the daily design volume. In the recirculation tank, one or more recirculation pumps were utilized, together with a control system “controller” including a high water and low water sensing means and an alarm system for indicating failure of one or both of the pumps. The controller controls which pump operates and in the event that one pump failed to operate satisfactorily the controller will sense this and operate the other pump. The outlet of the recirculation pumps the effluent back through lines 11 and 60a, b, c and nozzles 61 which directed the sprayed effluent onto the media through the air above the media in the basin for even distribution of the effluent over the top surface of the first and second media sections.

### Refer to FIGS. 1 and 2

The recirculated effluent entering the first media section was retained by the media a sufficient time for the aerobic bacteria in the media to reduce the bacterial count substantially before being displaced by additional effluent applied by the dosing pumps into the media about 6 inches below the top surface. The recirculated effluent displaced from the first media section contacted the bottom wall of the basin and flowed to the drain openings 18, 19, 20 or more and out through drain lines 8a, b, c or more and 28 to the recirculation tank and was again recirculated.

Oxygen dissolved in the recirculated effluent and free oxygen carried with the recirculated effluent into the media promoted bacterial degradation of the suspended solids held by the media and promoted oxidation of the BOD so that the effluent discharged was not only free of suspended solids and other contaminants but had a low bacterial count and a lowered nitrate count.

Effluent discharged from an intermittent filter system can be expected to have a bacterial count of as much as 2,000,000 fecal organisms per 100 ml. The Hines-Favreau system illustrated in can be expected to discharge an effluent having a bacterial count ranging from about 200,000 to 500,000 fecal organisms per 100 ml. The system described and claimed herein, however, is capable of discharging an effluent containing less than 5 BOD, 5 Suspended Solids, 50 fecal organisms per 100 ml and a reduced (lower) nitrate level, depending on the design flow loading, wastewater strengths entering and discharge requirement.

For control of nitrate reduction within the system as follows:
1. Piping from the recirculation and/or discharge tanks could direct a percentage of the recirculation and/or discharge effluent to pump a variable volume and place this recirculation or discharge effluent into the collection/septic tank and/or NRF tank. See FIG. 1
2. FIG. 2. For possible control of nitrates in the effluent a NRU tank/vessel is located after the collection/septic tank. A portion of the recirculation and/or discharge water can be directed into the collection/septic tank and/or into the first chamber of the NRU tank/vessel. The collection/septic tank and the NRU tank/vessel can have one or a multiple of chambers. The effluent, after passage through the NRU tank/vessel then flows to the dosing tank/vessel and then into the media basin for distribution therein.

Having thus described in detail, the preferred embodiment of the present invention. It is to be apparent that skilled contractors and others consider physical changes of the current invention. This preferred embodiment is therefore to be considered in all respects, as illustrative and not restrictive. The scope of the features of this invention being indicated by the claims be they appended at this time, rather than by the forgoing description, and all claims and changes which come with the meaning of range of equivalency of claims, are therefor to be embraced and embodied therein.

We claim:

1. A method for RECLAMATION of wastewater comprising: effecting liquid-solid separation of the gravity settleable solids portions of the wastewater to give an anaerobic effluent, distributing the anaerobic effluent with the settleable solids removed into and beneath the upper surface of a first media section bed comprising particles of media conducive to the growth and maintenance of aerobic bacteria organisms at a rate sufficient to allow the media to retain the effluent therein for a first retention time in the first media section before displacement by additional effluent and gravity, collecting the displaced aerobically treated effluent from the media at a collection point or points in the first media section, collecting this displaced aerobically treated effluent in a tank (vessel), distributing the collected and displaced aerobically treated effluent evenly over the same bed of the first media section for retention within the first media section a second or more retention time sufficient for the aerobic bacteria in the first media section to substantially reduce the bacterial count of the wastewater before displacement by additional effluent or aerobically treated effluent and gravity, the collected and displaced aerobically treated effluent from the first media section containing dissolved oxygen and carrying free oxygen with it is collected and returned into a tank, the collected aerobically treated effluent that arrives into the second media section is retained a sufficient time for the aerobic bacteria in the second media section to substantially reduce the bacterial counts before displacement by additional aerobically treated effluent, collecting and discharging the aerobically treated effluent displaced a first time from the second media section.

2. The method of reclamation of claim 1 wherein substantially all of the aerobically treated effluent first displaced from the first media section is collected and distributed evenly over the top surface of the first and second sections of the media by timed-control spraying for retention and displacement therefrom a second or more times and wherein the aerobically treated effluent displaced in the second section is collected for discharge at a different point than the point of collection of the effluent first displaced from the first media section.

3. The method of claim 2, wherein the first and second media sections is coarse sand having a uniformity coefficient of variable percentages and an example of grain size distribution as follows and as determined by coefficient percentage:

| Sieve Size | mm | Percentages |
|---|---|---|
| Passing a ⅜″ sieve | 9.51 | 100 |
| Passing a No. 4 sieve | 4.76 | 30-60 |
| Passing a No. 8 sieve | 2.38 | 10-30 |
| Passing a No. 16 sieve | 1.19 | 2-8 |
| Passing a No. 50 sieve | 0.297 | 0 |

4. The method of reclamation of claim 1, including controlling the amount of anaerobic and aerobically treated effluent distributed to the media to allow retention of the effluent within the media a time sufficient for bacterial action and biodegradation of the suspended solids, BOD, fecal coliform and nitrates in the effluent to take place.

5. The reclamation system of claim 1, including controller timed control means operatively connected to the subsurface distribution systems flow to the first media section.

6. An on/off-site WATER RECLAMATION SYSTEM providing an aerobically and oxygenated treated effluent containing minimal suspended solids, low BOD, low bacterial count, lowered nitrate count and high dissolved oxygen count, comprising:
A collection/septic tank having an inlet receiving untreated wastewater containing solids therein and an outlet connected to a subsurface effluent distribution means, the septic tank effecting solid-liquid separation and delivering an anaerobic untreated effluent to the subsurface distribution means, a basin containing particles of a media conducive to the growth and maintenance of aerobic bacteria organisms for the biological treatment of wastewater, subsurface effluent distribution means positioned within the particles of the first media section in the basin which receive the untreated anaerobic effluent from the dosing tank after the collection/septic and NRU tank and distribute it through the first media section for retention thereby for facultative and aerobic bacterial action and biodegradation of the suspended solids until displaced by additional effluent, aerobically treated effluent and gravity, the subsurface distribution means including a first subsurface distribution system for distribution of the untreated effluent within a first media section, first outlet means in the bottom wall of the basin beneath the subsurface distribution means for collecting aerobically treated effluent displaced from the first media section, a recirculation tank receiving the displaced aerobically treated effluent discharged from the first outlet means in the basin, means for timed-controlled pumping of the displaced aerobically treated effluent from the recirculation tank and injecting it into the air above the basin for even distribution across the surface of the first and second media sections in the basin for retention by the media a second or more times in the first media section and one time retained by the media in the second media section, the recirculated aerobically treated effluent displacing retained aerobically treated effluent held within the first and second media sections, second outlet means in the second media section basin receiving a portion of the aerobically treated effluent retained and displaced from the media, and means connecting with the second outlet from the second media section basin receiving the aerobically treated effluent for discharge.

7. The reclamation system of claim 6, including timed controller means operatively connected to the first subsurface distribution systems and the recirculation second distribution system.

8. The reclamation system of claim 7, including the timed controller means hardware and software connected to the first subsurface distribution system, the recirculation second distribution system, float switches, providing for monitoring of the float switches, pumps and controlling and monitoring the systems operation.

9. The reclamation system of claim 1 and claim 6, including an allowance of a plurality of different custom design aeration systems to allow contracted nitrogen/ammonia rate variances prior to discharge, according to a plurality of needs in the final required discharge results, this allowance of formulation is not a forecastable design specific claim as it is encompassed as an allowance accepted within the preferred embodiment of the present invention and to include within the reclamation system of claim 1 and 6.
